(19) United States
(12) Patent Application Publication
(10) Pub. No.: US 2013/0167037 A1
(43) Pub. Date: Jun. 27, 2013

(54) INTEGRATED SERVICE FEATURE GATHERING AND SELECTION SYSTEM

(71) Applicant: Zhenning Xaio, Renton, WA (US)

(72) Inventor: Zhenning Xaio, Renton, WA (US)

(21) Appl. No.: 13/560,994

(22) Filed: Jul. 28, 2012

Related U.S. Application Data
(63) Continuation-in-part of application No. 13/333,454, filed on Dec. 21, 2011.

(51) Int. Cl. G06F 3/01; G06F 15/16

(52) U.S. Cl. 715/738

(57) ABSTRACT

Techniques are disclosed for providing and using an integrated service feature gathering and selection system that can be used to send service requests to multiple network services. In an embodiment, a user interface that allows a user to select features and options for a service job without knowing which network service will eventually process the service job. Based on the selected features and options, the application program (or a network server if the user interface is Web-based instead of client-based) determines the network service to which the service job will be sent. In an embodiment, a network server receives capabilities data from multiple network services and builds, based on the capabilities data, a database of network service description data, from which the user interface that is displayed to a client device is generated.

### CROSS-REFERENCE TO RELATED APPLICATIONS

This application is a continuation-in-part of U.S. patent application Ser. No. 13/333,454, filed Dec. 21, 2011, the entire contents of which is hereby incorporated by reference as if fully set forth herein.

### FIELD OF THE INVENTION

The present invention relates to network service management and, more particularly, to retrieving information about multiple network services and integrating that information in a user-friendly way to end-users in order to use one or more of the network services.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Due to the Internet and Web technologies, the number of network services has been growing rapidly. Most users, after discovering a network service (e.g., a translation service) with which they are satisfied, will return to that service whenever they have a need for that particular service. However, such a one-application-per-service model has become cumbersome for users as there are thousands of services available on the Internet. Keeping tracking of all the available network services is difficult for even experienced Web users.

Furthermore, if there are multiple network services that provide a similar service and a user desires to use one of them, then the user must individually examine each network service separately and remember (or record) all the features and options provided by each in order to compare the network services and determine which network service to use. Also, each network service provides its own user interface (UI), with which the user must become familiar.

Additionally, some network services require a client program to execute on a client device in order for a user to utilize the network services. Thus, a user might have to manually install, into the local operating system of the user's device, an application program for each network service. Such installation might require the user to first know the exact model of his/her client device and then download a compatible application program from the network service.

### SUMMARY

Techniques are provided for receiving, at a client device, service feature and option data that include features and options supported by a plurality of network services. An application program executing on the client device generates a user interface based on the service feature and option data. The user interface indicates the features and options supported by the plurality of network services. Input that selects one or more features and options reflected in the service feature and option data is received through the user interface. Based on the input, the application program selects a particular network service from among the plurality of network services and generates a service job based on the selected one or more features and options. The application program causes the service job to be sent to the particular network service.

### BRIEF DESCRIPTION OF THE DRAWINGS

In the drawings:

FIG. 1 is a block diagram that depicts an example network service feature gathering and selection system, according to an embodiment;

FIG. 2 is a block diagram that depicts example components of a service server and of an integrated service client, according to an embodiment;

FIG. 3 is a block diagram that depicts a data flow of network service information from multiple network services to a service server, according to an embodiment;

FIG. 4 is a flow diagram that depicts a process for adding a connected network service to a service server, according to an embodiment;

FIG. 5 is a sequence diagram that depicts a process for creating user interface data, according to an embodiment;

FIG. 6 is a block diagram that depicts example generic service description data for each of a server, a client, and a user interface, according to an embodiment;

FIG. 7 is a block diagram that depicts an example user interface, according to an embodiment;

FIG. 8 is a flow diagram that depicts a process for a user changing a filter preference, according to an embodiment;

FIG. 9 is a flow diagram that depicts a process for a user changing a feature/option on a user interface (UI) of a service client, according to an embodiment;

FIG. 10 is a flow diagram that depicts a process for validating user selections of features of options, according to an embodiment;

FIG. 11 is a flow diagram that depicts an example of how a service ticket is created, according to an embodiment;

FIG. 12 is a diagram that depicts an example process for adding a service provider to a service server;

FIG. 13 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

Embodiments include an integrated service feature gathering and selection system. In an embodiment, a single, combined UI for managing multiple network services is presented. In an embodiment, an application program system dynamically queries and updates itself (e.g., automatically or upon being requested) with all connected network service information across mobile or business network environments. The application program system simplifies the process of multi-service management and provides a straight-forward user experience under complicated network environments.

In an embodiment, an application program enables a computer operating system (OS) to manage multiple network services in dynamic environments. Network services can be connected via a local Ethernet network or via a remote network through internet protocol. An OS might assign a unique port for each connected network service and provide APIs for data communication. The application program provides a unified, feature-oriented UI for multiple network services and automatically selects a network service according to a user's selections.

In a related embodiment, a client device executes a browser that requests a unified, feature-oriented UI for multiple network services and automatically selects a network service according to the user's selections.

### Service Feature Gathering and Selection System

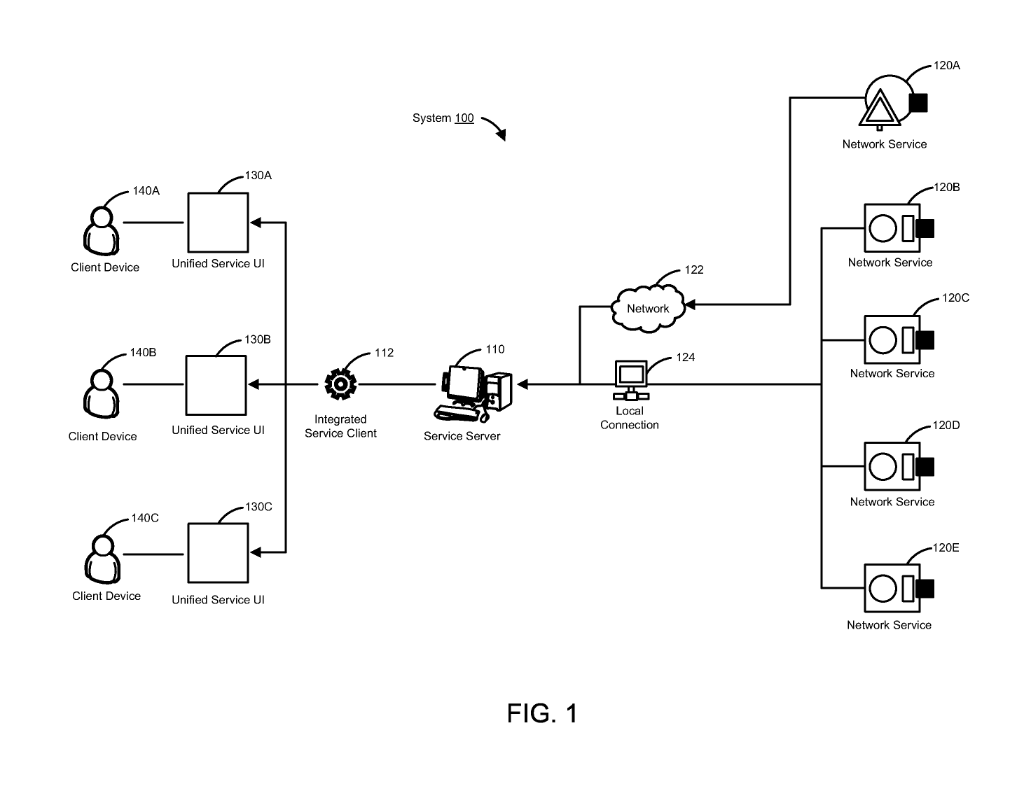

FIG. 1 is a block diagram that depicts an example service feature gathering and selection system 100, according to an embodiment. System 100 comprises a service server 110, an integrated service client 112, network services 120A-E, network 122, local connection 124, unified service UIs 130A-C, and client devices 140A-C.

Service server 110 is a network device that comprises one or more processors and memory and that is communicatively coupled to network services 120A-E and client devices 140A-C. Service server 110 communicates with network service 120A via network 122 and communicates with network services 120B-E and user client 130A-C via a local connection 124. Examples of network 122 include, without limitation, a Wide Area Network (WAN), the Internet, or one or more terrestrial, satellite or wireless links. Examples of local connection 124 include, without limitation, a Local Area Network (LAN), Ethernet, or one or more terrestrial, satellite or wireless links.

Service server 110 receives service capabilities data from network services 120A-E. Services capabilities data is data that specifies a network service's currently supported features and options, i.e., allowed values for each feature, of network services 120A-E. Because the number and type of network services 120A-E are virtually limitless, examples of network service features are similarly virtually limitless. In the print context, example features include paper size, orientation, duplex, print quality, color, etc. Each feature has one or more options, i.e., values. For example, duplex unit has two options, such as “Installed” or “Not Installed.” Other features, for example, paper size, may have many options, e.g., “A4”, “legal”, “8½×11”, etc.

Embodiments are not limited to any particular technique for communicating between service server 110 and network services 120A-E in order for service server 110 to obtain service capabilities data about network services 120A-E. For example, such communication might be achieved through Simple Network Management Protocol (SNMP) or Web Services for Devices (WSD) technologies. Recent development of WSD technologies on a network provides opportunities for more advanced device management (e.g., relative to SNMP). Such development allows any network service to report its full service capabilities during the establishment of a connection between the network service and another network service, such as a network server. Thus, service server 110 might communicate with network service 120A using one communications protocol (in order to receive service capabilities data and, optionally, send service jobs or requests) and might communicate with network service 120B using a different communications protocol.

Service server 110 may automatically detect one of network services 120A-E, whether the detection is initiated by service server 110 or the network services themselves. Additionally or alternatively, service server 110 may be notified of one or more of network services 120A-E by an administrator. Upon detection, service server 110 queries the detected network service (local or remote) for information about the network service including, but not limited to, service features and options and other capabilities supported by the network service.

Based on the service capabilities data, service server 110 generates integrated service client 112. Service server 110 then sends integrated service client 112 to one or more of client devices 140A-C. Additionally or alternatively, service server 110 sends the service capabilities data to one or more of client devices 140A-C that (already) execute an integrated service client at the time service server 110 receives the service capabilities data. Such “already-existing” integrated service clients are automatically updated to include the new service capabilities data.

The functionality of service server 110 may be implemented using stored program logic, in a special-purpose computer or loaded from one or more non-transitory media into the memory of a general-purpose computer and then executed.

Client devices 140A-C may be implemented as any type of client device. Examples of client devices 140A-C include, without limitation, personal or laptop computers, workstations, tablet computers, cellular telephony devices such as cell phones, personal digital assistants (PDAs), etc.

Service server 110 builds an information database and creates various data structures (e.g., an XML file) for integrated service client 112. Such data structures may be accessed by UI components of integrated service client 112 when client 112 displays an integrated UI to a user of one of client devices 140A-C.

After integrated service client 112 is received by and installed at client devices 140A-C, service client 112 displays an integrated UI that contains features from multiple network services (e.g., network services 120A-E). Some features on the UI are automatically enabled or disabled based on a feature set a user has previously selected and whether any network services can support the selected feature set. Based on the feature set of the user's selection, service client 112's UI determines which network service will be used, and then saves the feature set to a destination service job ticket. A rendering component of service client 112 sends a service job to a network service (e.g., network service 120C) defined in the service ticket.

The service job ticket is in a form that is recognizable by the target network service. For example, if the network service is a web site, then the service job ticket may be a Uniform Resource Location (URL) that includes parameters and/or other URL components that identify or correspond to selected features and options. In response to receiving the generated URL, the network service provides content (e.g., a web page) that the client device displays in a web browser or a separate application that is dedicated to the network service.

In a related embodiment, instead of generating and sending an integrated service client 112 to each client device 140, service server 110 provides a web service that client devices 140A-C access, for example, via a web browser or a dedicated application. In this way, integrated service client 112 would not have been updated whenever a new network service is discovered or an additional feature is supported by a known network service.

### Service Client Components

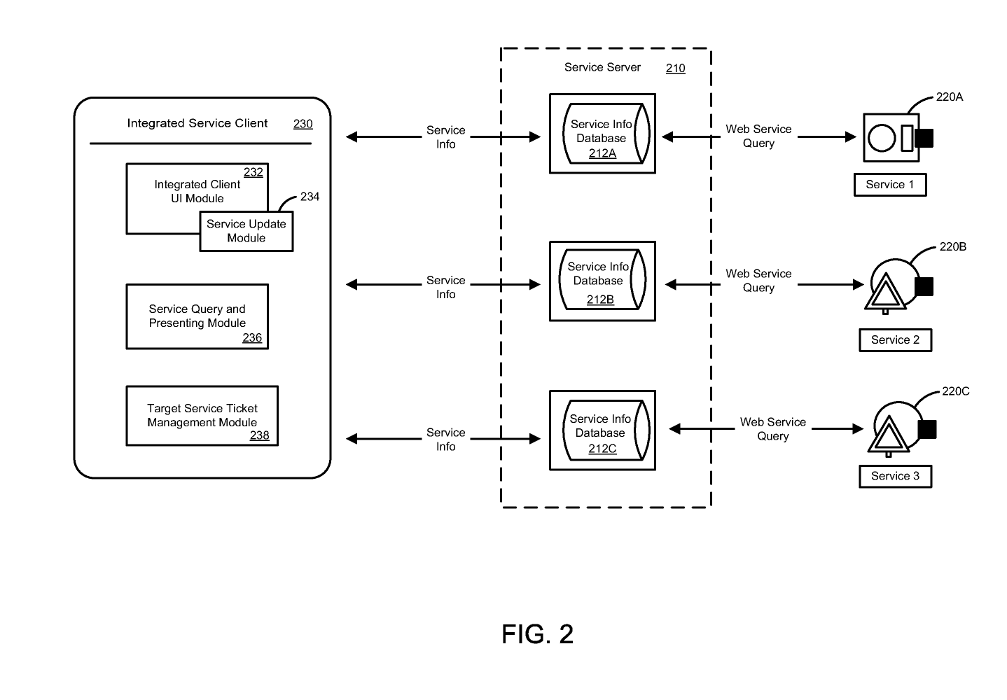

FIG. 2 is a block diagram that depicts example components of a service server 210 and of an integrated service client 230, according to an embodiment. Service server 210 may be the same server as service server 110. Service server 210 includes service information databases 212A-C, one for each of network services 220A-C. Thus, service information database 212A contains information about network service 220A, service information database 212B contains information about network service 220B, and so forth. Although depicted as separate databases 212A-C, databases 212A-C may be stored on the same storage device (not depicted).

According to FIG. 2, service server 210 communicates with network service 220A and 220C using Web Services Discovery in order for service server 210 to retrieve information (including features and options) about network service 220A and 220C. Web Service Discovery is one example of a standard discovery protocol that service server 210 and network service 220A and 220C implement, or at least a version thereof. Also, service server 210 communicates with network service 220B using SNMP (or Simple Network Management Protocol).

In FIG. 2, integrated service client 230 executes on a client device and includes four components: integrated UI module 232, update module 234, service query and presenting module 236, and target service ticket management module 238. Integrated UI module 232 generates a user interface (UI) and causes the UI to be displayed on a screen of the client device upon which integrated service client 230 is installed. Update module 234 is responsible for obtaining information from service server 210 about one or more network service that service server 210 discovers after integrated service client 230 is installed on the client device.

Service query and presenting module 236 receives feature selections (whether user selected, default, or a combination of both), determines which network service of multiple network services to use, and generates a service job that reflects the feature selections and, optionally, one or more documents. Service query and presenting module 236 passes the service job to integrated target service ticket management module 238. The service job is reflected in the service request. The format of the service request varies depending on the type of network service and/or the communications protocol required to communicate with the selected network service. For example, if the network service is a web site, then the service request may be reflected in an HTTP request message. If the network service is a web service, then the service request may be reflected in a SOAP message.

Integrated service port management module 238 is responsible for sending the service job to the appropriate network service. Integrated service port management module 238 may implement one or multiple communication protocols in order to send the service job to the appropriate network service. For example, service client 230 might send one service job to a first network service identified in service client 230 via Web Services Device port and service client 230 might send one service job to a second network service identified in service client 230 via a TCP/IP port.

### Network Service Information Data Flow

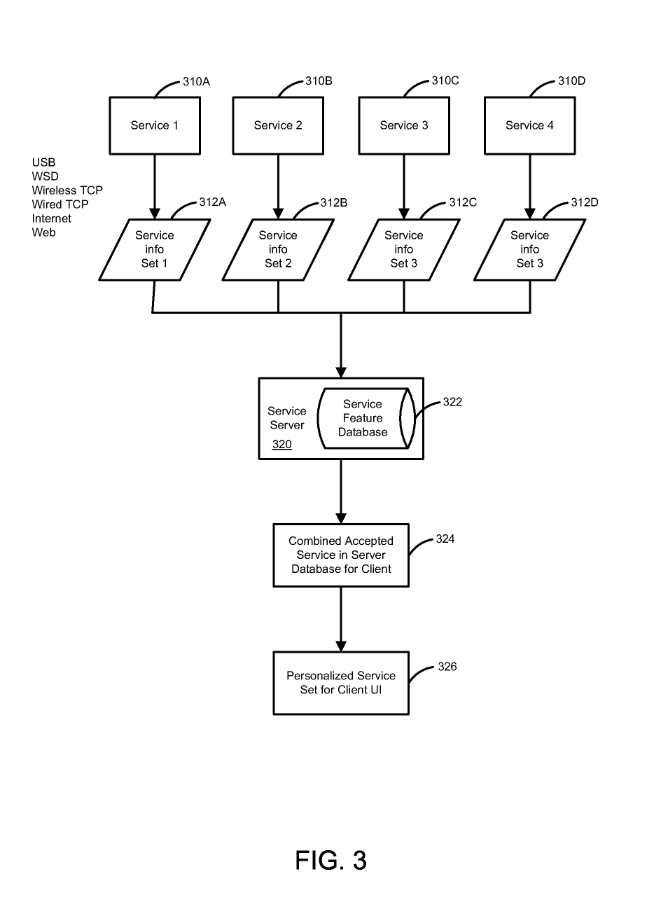

FIG. 3 is a block diagram that depicts a data flow of network service information from multiple network services 310A-D to a service server 320, according to an embodiment. Service server 320 may be the same server as service server 210 and/or service server 110. Each network service 310 sends a set of service information to service server 320. For example, network service 310A sends service information set 312A to service server 320, network service 310B sends service information set 312B to service server 320, and so forth. Network services 310A-D may communicate with service server 320 using one of communication methods, such as USB (or Universal Serial Bus), wireless TCP, and wired TCP, or the Internet. Although FIG. 3 depicts four network services 310A-D, other embodiments of the invention may include more or fewer network services.

Service server 320 receives service information sets 312A-D and, in an embodiment, applies one or more filter criteria to service information sets 312A-D. The one or more filter criteria may be used to identify which network services are not allowed to be used (or “seen”) by client devices that are connected to service server 320. In this embodiment, service server 320 compares the one or more filter criteria to one or more attributes of a network service (e.g., 310A), which are reflected in a service information set (e.g., 312A) received from that network service. Example filter criteria include whether the network service supports a certain security policy or any security, whether the network service supports a particular page description language (PDL), or whether the network service is from a particular domain or subdomain. Additionally or alternatively, one or more filter criteria includes a list of network services that are allowed to be used by client devices that are connected with service server 320 (e.g., a “white” list) or a list of network services that are not allowed to be used by client devices that are connected to service server 320 (e.g., a “black” list).

The one or more filter criteria may be established by a company administrator, or an administrator that is authorized by a business entity that owns and/or manages service server 320.

If a network service is not “filtered out” after the filter stage, then service server 320 stores the service information set of that network service in a service feature database 322. The data stored therein is referred to as the server generic service description data (or “Server GSDD”). The Server GSDD, on a server when a client device is connecting to a corporate domain network, or on the client device when the client device is disconnected from a corporate domain network, defines information on all network services (whether connected or not connected) that are available for all users of that client device.

In an embodiment, service information sets of network services that are “filtered” out after the filter stage are stored separate from the Server GSDD. Such storage may be on the same storage device that stores on the Server GSDD or on a different storage device. Such service information sets may be maintained if, for example, the one or more filter criteria are later changed or updated, for example through user input. In such a scenario, the “excluded” service information sets may be evaluated again based on the updated filter criteria. Such a re-evaluation might be triggered based on the changing of the one or more filter criteria. One or more of the excluded service information sets might then pass the filter stage and end up being stored as part of the Server GSDD.

In an embodiment, the Server GSDD may be filtered based on one or more additional filter criteria. Such additional criteria may be established by a client administrator, who may be the same or different than the administrator that defines the filter criteria referenced above. Examples of such additional filter criteria include those criteria described previously and whether a particular user is allowed to use a particular network service, which may be determined in multiple ways, such as a pre-defined list of network services that the particular user is allowed to use. The service information sets of network services that are not “filtered out” by this additional filter criteria are referred to as “Client GSDD.” Client GSDD 324 is a subset of the Server GSDD and defines information on all network services (whether connected or not) that are available for a particular user. Thus, each client device that is communicatively coupled to (or registered with) service server 320 might receive a different Client GSDD. For example, the Server GSDD may include information only about network services 310A-C and not network service 310D. Afterward, Client GSDD 324 for one client device might include information only about network services 310A-B while Client GSDD 324 for another client device might include information only about network services 310A and 310C.

The Client GSDD 324 of a particular user becomes part of an integrated service client (whether generated by service server 320 or another entity) that is installed on a client device of the particular user. Alternatively, in a non-client scenario, client GSDD 324 is stored for each client device. If multiple client devices are associated with the same network services, then a single client GSDD may be associated with the multiple client devices.

In an embodiment, the Client GSDD 324 is filtered by one or more filter criteria that are defined by the associated user. For example, the associated user might indicate that s/he only wants to see information about network services that are of a particular type (e.g., educational, entertainment), that are free, and that provide video content. Whichever service information sets satisfy the filter criteria defined by the user will be part of a “UI GSDD” 326. The UI GSDD 326 for a particular user defines information on all connected network services that are available for the particular user. The UI GSDD 326 may be updated in real-time as the particular user makes selections about what characteristics or attributes a set of network services must have in order to be candidate network services for service jobs that are initiated by the particular user.

### “Adding” a New Network Service to a Service Server

A network service is “added” to a service server when a service server obtains details about the network service, such as an address (e.g., IP or MAC) of the network service, communication protocol(s) that the network service supports, and set of features and options that the network service supports.

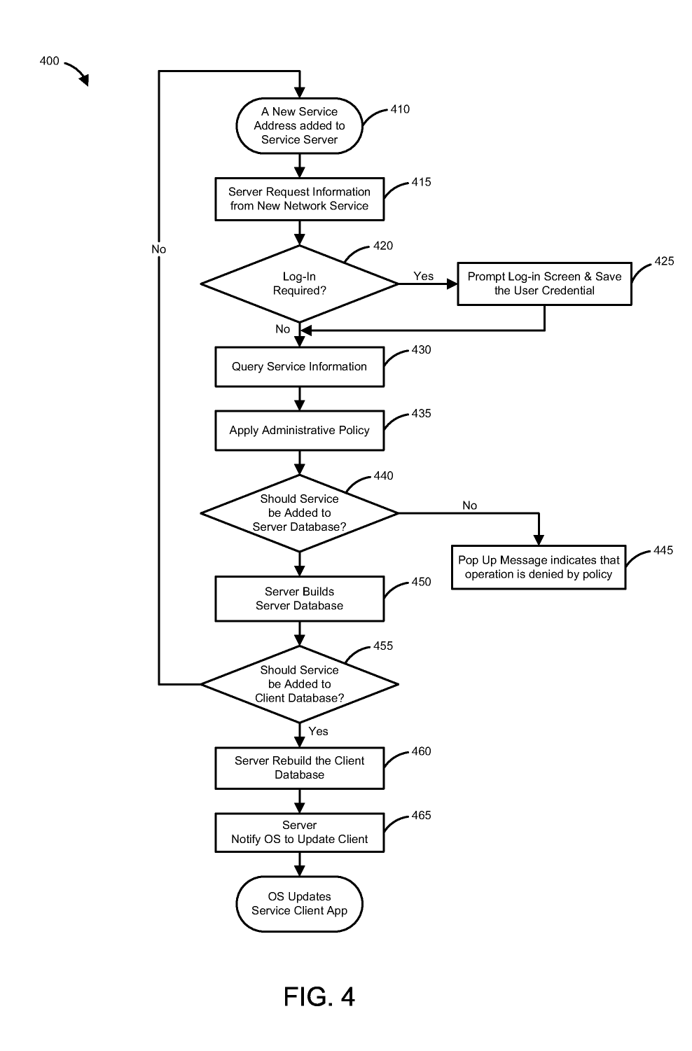

FIG. 4 is a flow diagram that depicts a process 400 for adding a connected network service to a service server, according to an embodiment. At step 410, a user provides, to service server, input about a new network service. Such input might include a network IP, an Internet IP or a MAC address of the network service. The network service may be local to (i.e., on the same network as) or remote to (i.e., not on the same network as) the service server.

Alternatively, step 410 comprises the service server automatically detecting the new network service. Such automatic detection may be achieved in multiple ways. For example, upon the new network service entering the network, the new network service implements a Web Services Discovery specification by transmitting a HELLO multicast message to devices on the network. The service server receives the HELLO message, responds with a message that identifies the service server. If both the service server and the new network service implement a Web Services Metadata Exchange specification, then the service server sends a metadata request message to the new network service in order to retrieve information about how to request certain information about the new network service, such as capabilities data.

At step 415, the service server sends a request to query the new network service for certain information, such as capabilities data of the network service, any security protocols the network service supports, etc.

At step 420, it is determined whether a log-in is required. If so, then process 400 proceeds to step 425 where a log-in screen is displayed and user credential information is saved, after which process 400 proceeds to step 430. If a log-in is not required, then process 400 proceeds to step 430, where the service server queries the service information of the new network service.

At step 435, the service server applies an administrative policy to at least some of the information retrieved from the network service. The administrative policy may indicate that the network service must support a certain type of secured connection and that the network service appears on trusted service provider list.

At step 440, the service server determines, based on the administrative policy, whether the network service should be added to the Server GSDD. If not, then process 400 proceeds to step 445, where the service server causes a message to be displayed that indicates that the “add” operation is denied. If the service server determines that the network service should be added to the Server GSDD, then process 400 proceeds to step 450.

At step 450, the service server builds the Server GSDD database. This step may comprise adding the retrieved information about the new network service to the Server GSDD database.

At step 455, the service server uses another policy to determine whether the new network service should be added to a client GSDD. The other policy may be defined by a client administrator and determines whether a client device is able to “see” certain network services. If the result of step 455 is in the negative, then process 400 proceeds to a point prior to step 410, indicating that further input regarding a new network service is required to proceed. If the result of step 455 is in the affirmative, then process 400 proceeds to step 460.

At step 460, the service server rebuilds a Client GSDD. This step may comprise adding the retrieved information about the new network service to an existing Client GSDD.

At step 465, the service server sends the retrieved information to an operating system of a client device that executes a service client. At step 470, the operating system updates the service client based on the retrieved information. Alternatively, a user might decide to update the service client at a later time.

### Creating User Interface Data

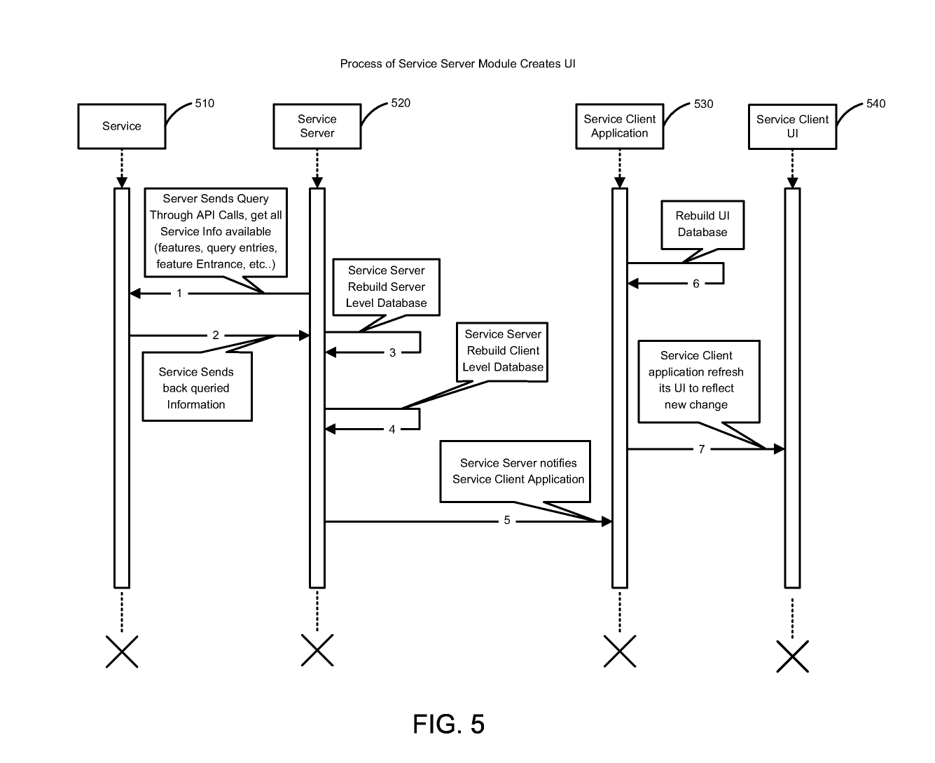

FIG. 5 is a sequence diagram that depicts a process 500 for creating user interface data, according to an embodiment.

At step 1, a service server 520 sends one or more queries to network service 510 in order to receive information about network service 510, including capabilities of network service 510. One or more techniques may be used to send the one or more queries, including, but not limited to, a WS Discovery query, OS network API, etc.

At step 2, network service 510 sends, to service server 520, the information that service server 520 requested.

At step 3, service server 520 checks one or more company or domain administrative policies and builds (or rebuilds) a Server GSDD based on the retrieved information.

At step 4, service server 520 checks a client policy and builds (or rebuilds), based on the retrieved information, a Client GSDD for each user that is authorized to use network service 510.

At step 5, service server 520 sends the retrieved information to one or more service clients 530 via, for example, an OS of each client device of the one or more corresponding client devices. An OS, in turn, notifies a client update module that is part of the service client 530.

At step 6, service client 530 rebuilds an existing UI GSDD.

At step 7, service client 530 updates the client's UI to reflect the one or more features of the new network service 510. If a client UI module of service client 530 is already processing a job, then service client might include adequate solutions to ensure that the new UI update does not affect existing service jobs.

### Example GSDD

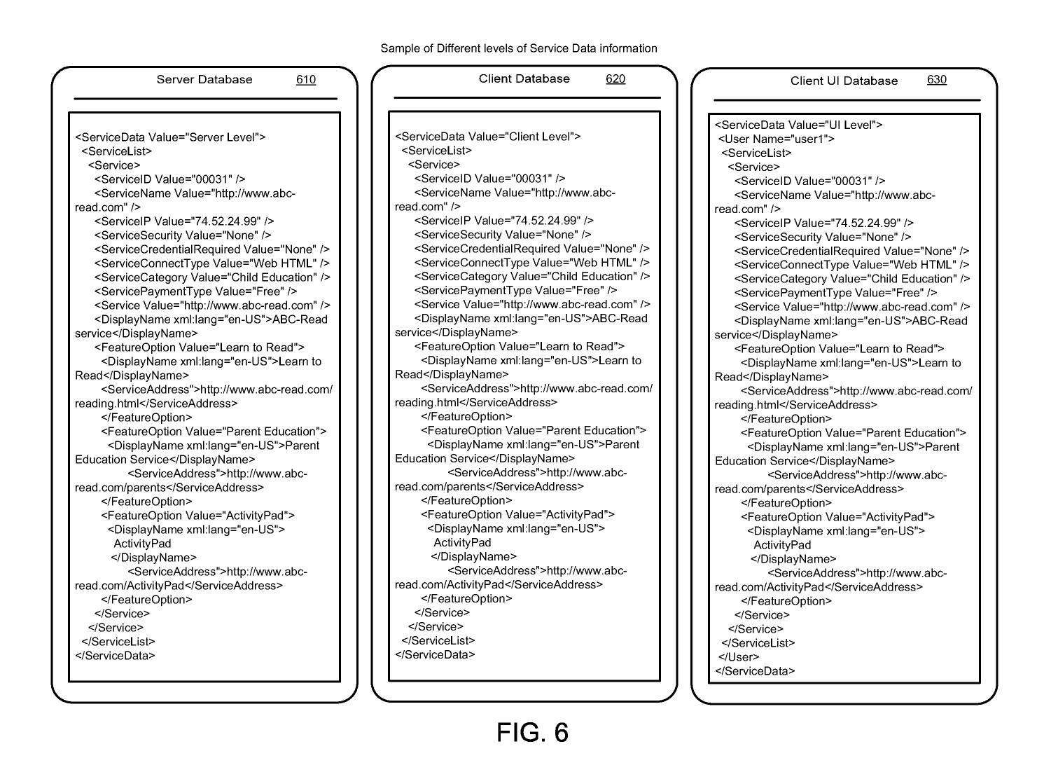

FIG. 6 is a block diagram that depicts example generic service description data for each of a server, a client, and a user interface, according to an embodiment. FIG. 6 depicts an example Server Database (or GSDD) 610, an example Client Database 620, and an example Client UI Database 630. Although databases 610-630 are in an XML format, embodiments of the invention are not limited to GSDDs in an XML format. Alternative formats are possible.

In this example, each of databases 610-630 include the same information of a network service, such as attributes of the network service (e.g., name, IP address, payment type, category type, connection type, ID, etc.) and capabilities data that includes three feature options. Also, each of databases 610-630 includes a different value for the ServiceData Value. Specifically, Server Database 610 indicates “Server level” as the value for the ServiceData Value, Client Database 620 indicates “Client Level” as the value for the ServiceData Value, and Client UI Database 630 indicates “UI level” as the value for the ServiceDataValue.

### Example Service Client User Interface

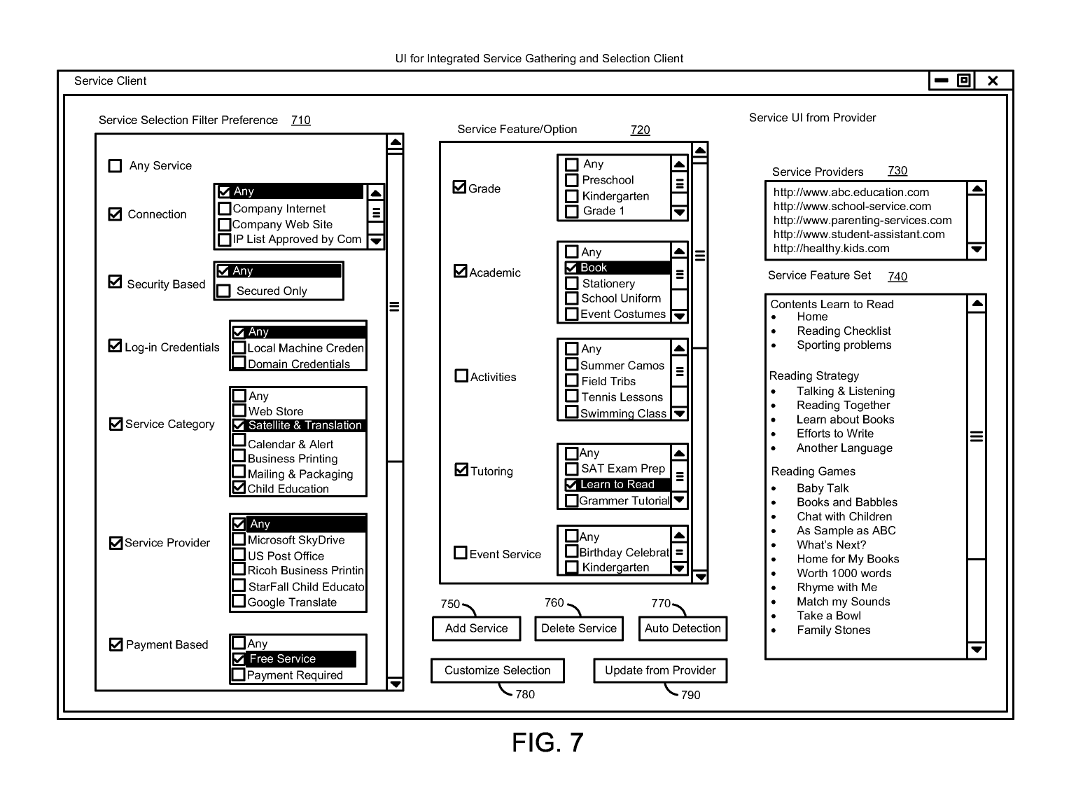

FIG. 7 is a block diagram that depicts an example user interface 700, according to an embodiment. User interface 700 may be generated by a UI module of a service client. Alternatively, user interface 700 is provided by a web server hosted by service server 110. A web browser on a client device may request user interface 700 from the web server over a network. Alternatively, a client device executes a non-browser application (e.g., a “smartphone” application) that requests user interface 700 from service server 110 over network. Regardless of how user interface 700 is displayed on a client device, the data used to populate user interface 700 may originate from a UI GSDD.

User interface 700 comprises four parts or regions: service selection filter preference 710, a service feature/option list 720, a service provider list 730, and a service feature set 740.

Service selection filter preference 710 defines service attributes/characteristics that are used to exclude some network services that a user does not intend to use. The service preferences of a network service (such as the type of connection or name of service provider) are not related to the actual service(s) that the network service provides. In contrast, service features/options are related to what a network service provides.

For example, a user may select “IP List Approved by Company” from the “Connection” preference as a filter, which causes only service providers that are listed on the “IP List” to be displayed as possible service providers in service provider list 730. If one or more service providers are excluded as a result of that user selection, then service feature/option list 720 may be dynamically updated to reflect the new (updated) set of potential service providers.

In the depicted example, the service preferences are that the network service may have any type of connection, may have any type of security, may have any type of log-in credentials, must be from the Spelling Translation and/or Child Education categories, may be any service provider, and must be a free service. However, if the “Any Services” filter preference is selected, then user interface 700 may be dynamically updated to list all network services in service provider list 730 (unless some features/options are already selected in service feature/option list 720) and all possible service features/options in service feature/option list 720.

Service feature/option list 720 lists multiple (or all) features and options supported by a set of one or more network services that are determined based on a set of selection preferences selected by a user (and/or by default). In an embodiment, each time a user changes a feature or option from service feature/option list 720, the resulting set of features is validated by a service client against the capabilities of potential network services (e.g., those indicated in a Client GSDD). If a network service does not support the resulting set of features, then all of that network service's features are disabled in service feature/option list 720. However, if there is a network service that does support the resulting set of features, then all of that network service's features are enabled in service feature/option list 720.

In this example, service feature/option list 720 divides service features into five main types: Grade, Academic, Activities, Tutoring, and Event Service. The feature Academic is selected along with the option “Book.” Also, the feature Tutoring is selected along with the option “Learn to Read.”

Service provider list 730 lists one or more (or all) network services that are within a set of possible destination network services after the user's preferences are defined in service selection filter preference 710 and service features are selected in service feature/option list 720. In the depicted example, five network services are listed in service provider list 730. In other words, the five listed network services are identified, from among a larger set of service providers, as satisfying all the selected (whether user-selected and/or default-selected) requirements.

In an embodiment, selection of one of the network services listed in service provider list 730 causes a web browser to be directed to that network service. In an embodiment, the request for the network service includes one or more features/options that were selected from service feature/option list 720. For example, for a web service, an HTTP request is generated that includes one or more parameters that correspond to one or more of the selected features/options. In this way, a user may be presented with the exact information that the user is seeking without requiring the user to further select one or more features/options (at the selected network service) that the user already selected in user interface 700.

Service feature set 740 lists all the features and options provided by the service providers listed in service provider list 730. The features and options listed in service feature set 740 may decrease if the number of service providers listed in service provider list 730 decreases (e.g., due to a selection in service selection filter preference 710 or in service feature/option list 720). Conversely, the features and options listed in service feature set 740 may increase if the number of service providers listed in service provider list 730 increases (e.g., due to a selection in service selection filter preference 710 or in service feature/option list 720).

User interface 700 also includes five buttons: Add Service button 750, Delete Service button 760, Auto Detection button 770, Customize Selection button 780, and Update from Provider button 790. In an embodiment, one or more of these buttons are only displayed to an administrator, or a user with administrator rights, not any end-user. Selection of Add Service button 750 allows a user (or administrator) to manually add a new network service, for example, to a Service GSDD or a Client GSDD. Selection of Delete Service button 760 allows a user (or administrator) to manually delete a network service, for example, from a Service GSDD or a Client GSDD. Selection of Auto Detection button 770 causes a service client or a service server to send a HELLO message on a certain (e.g., local) network. The type of messages that may be sent is communication protocol dependent. Selection of Customize Selection button 780 allows a user (or administrator) to update (e.g., add or remove) service selection filter preference 710. Selection of Update from Provider button 790 causes a service client or a service server to require one or more network services, for example, that are listed in a Service GSDD or a Client GSDD.

### Changing a Selection Filter Preference

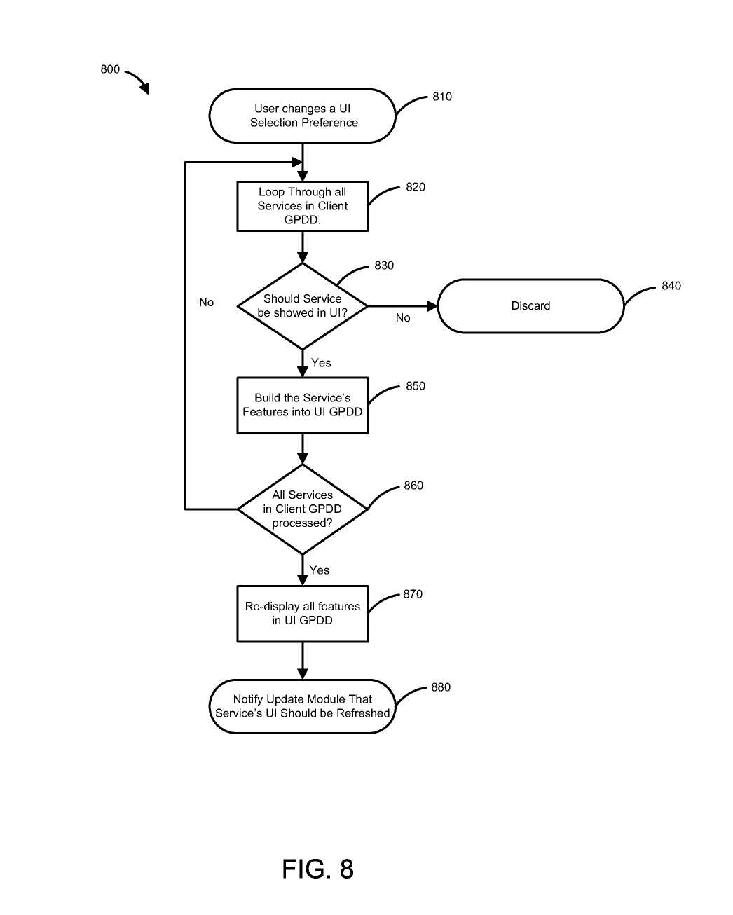

FIG. 8 is a flow diagram that depicts a process 800 for a user changing a filter preference, according to an embodiment. Process 800 may be performed by one or more components or modules of a service client, such as service update module 234 depicted in FIG. 2. Alternatively, process 800 may be performed by a service server, such as service server 220 in FIG. 2. Thus, while process 800 is described from the perspective of a client application, embodiments are not so limited.

At step 810, a user changes a UI selection preference. Examples of UI selection preferences include, but are not limited to, location (e.g., URL or IP address), security information, and fee-based service. The user might change the UI selection preference through a UI generated by a service client. As a result of performing step 810, the service client might delete all UI GSDD and rebuild it using the following process. Alternatively, the service client might delete, from a UI GSDD one at a time, only information about a network service that the service client determines should not be included in the UI GSDD based on the user's selection preference.

At step 820, the service client identifies a network service indicated in a Client GSDD to which the service client has access. The Client GSDD may be stored on the same client device that executes the service client.

At step 830, the service client determines whether the network service identified in step 820 should be displayed in a user interface that a user uses to select features and options for a particular service job. This determination may be made by comparing the current set of selection preferences with attributes/characteristics of the identified network service or by comparing just the changed preference with such attributes/characteristics. If step 830 results in the negative, then process 800 proceeds to step 840, where information about the identified network service is not included in (e.g., deleted from) the UI GSDD. If step 830 results in the affirmative, then process 800 proceeds to step 850.

At step 850, the service client adds the network service's capabilities (i.e., features and options) into a UI GSDD, from which the service client eventually generates a user interface.

At step 860, the service client determines whether information about each network service indicated in the Client GSDD has been analyzed. If not, then process 800 proceeds to step 820. Otherwise, process 800 proceeds to step 870.

At step 870, the service client causes all (or many) features and options indicated in the updated UI GSDD to be re-displayed on the client. Only the features and options of network services that are identified in the UI GSDD are displayed. Thus, information about any network services that were not included in the UI GSDD in step 850 is not displayed to a user of a client device that executes the service client.

At step 880, one or more applications that are currently using this service client are notified, e.g., by the service client.

### Changing UI Feature/Option

The selection of features and options under an integrated service client approach is different compared to other service clients. To support multiple devices in one user interface, the integrated service client should ensure that every feature set selection by a user is supported by at least one network service. Constraints to features are applied according to service support by any services. In other words, if none of the network services indicated in a UI GSDD supports a particular feature, then that particular feature appears disabled.

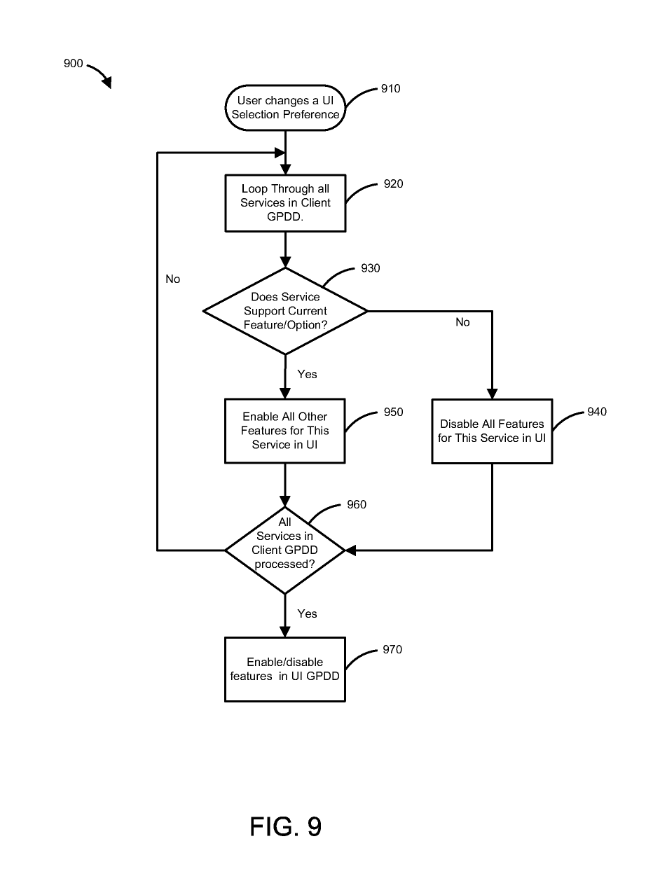

FIG. 9 is a flow diagram that depicts a process 900 for a user changing a feature/option on a user interface (UI) of a service client, according to an embodiment. Process 900 may be performed by one or more components or modules of a service client, such as integrated client UI module 232 depicted in FIG. 2. Alternatively, process 900 may be performed by a service server, such as service server 220 in FIG. 2. Thus, while process 900 is described from the perspective of a client application, embodiments are not so limited.

At step 910, the UI receives, from a user, input that indicates a change in a feature or option. Examples of a change include selecting the “Field Trips” option in the Activities feature of user interface 700.

At step 920, the service client identifies a network service indicated in a Client GSDD. If there are more than one network service identified in the Client GSDD, then the service client might “loop through” each identified network service. In other words, steps 920-960 will be performed for each identified network service.

At step 930, the service client determines whether the network service identified in step 920 supports the feature/option selected in step 910. If not, then process 900 proceeds to step 940. If so, then process 900 proceeds to step 950.

At step 940, the service client disables all features of the network service identified in step 920 if the network service does not support the feature/option set previously selected by user.

At step 950, the service client enables all features for this network service in the UI if the feature set previously selected by user is supported by the network service.

At step 960, the service client determines whether all network services have been identified in the Client GSDD. If not, then process 900 proceeds to step 920 to identify another network service. Otherwise, process 900 proceeds to step 970.

At step 970, for each feature enabled/disabled in the UI, the service client enables or disables that feature in a UI GSDD. Thus, if feature 1 is enabled in the UI, then the service client enables feature 1 in the UI GSDD. Conversely, if feature 2 is disabled in the UI, then the service client disables feature 2 in the UI GSDD.

### Confirm UI Selection

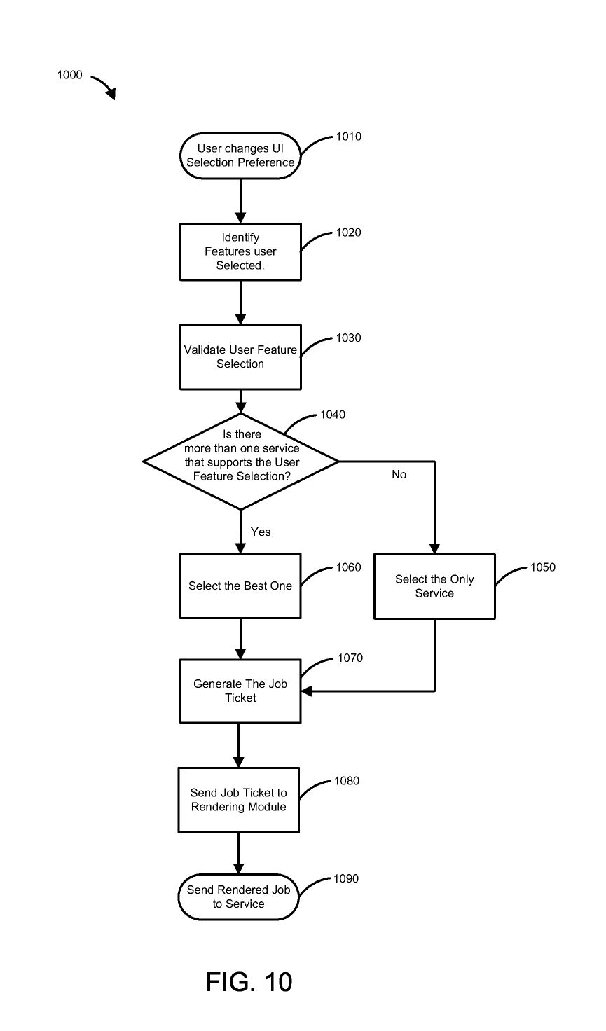

FIG. 10 is a flow diagram that depicts a process 1000 for validating user selections of features of options, according to an embodiment. Process 1000 may be performed by a service client, such as integrated service client 112. Process 1000 may be performed by one or more components or modules of a service client, such as service query and presenting module 236 and target service ticket management module 238 depicted in FIG. 2. Alternatively, process 1000 may be performed by a service server, such as service server 220 in FIG. 2. Thus, while process 1000 is described from the perspective of a client application, embodiments are not so limited.

At step 1010, a service client receives, from a user, input that indicates confirmation of the features and options selected for a service job. The input may be the user selecting an “OK” button. This step may be performed by a UI module of the service client, such as UI module 232 of service client 230 of FIG. 2.

At step 1020, the service client identifies all features and options that are selected for the service job. Some of the features and options may have been selected by the user while other features and options may have been default selections. Such default selections may have been established in code of the service client and/or established by the user in a previous service selection session. For example, a prior service job includes a set of features and options and those features and options are default selections (as indicated in the client's UI) for the current service job, i.e., before the user has viewed the UI.

At step 1030, the service client validates the selected features and options of the service job. For example, if a user selects an feature/option that is not supported by any network service, then the service client may inform the user to change the value before sending a service request to a selected network service.

At step 1040, the service client determines whether more than one network service supports the set of selected features and options. If not, then at step 1050, the service client selects the one network service. Otherwise, process 1000 proceeds to step 1060.

At step 1060, the service client selects a particular network service among the multiple network services that are capable of processing the service job according to the selected set of features and options. This selection may be based on determining which of the multiple network services is free, which provides the most secured connection, which does not require log-in credentials, or any other factor, such as which network service was added most recently, or which network service has the best reputation according to some standard.

At step 1070, the service client generates a service job ticket based on the selected features and options.

At step 1080, the service client sends the service job ticket to a query and presenting module of the service client, such as service query and presenting module 236 of service client 230 of FIG. 2. The query and presenting module may be implemented as a single module or as multiple modules that each might perform a different type of querying and presenting. Like step 1010, steps 1020-1080 may be performed by a UI module of the service client, such as UI module 232 of service client 230 of FIG. 2. The rendering module converts (1) document data received from and generated by an application (e.g., a Microsoft Word) executing on the client device into (2) print data that the network service is configured to be able to process. The service client might automatically detect the PDL supported by the destination network service and render the job accordingly. For example, the service client might identify an appropriate sub-module that is configured to perform the rendering that is appropriate for the destination network service and cause that sub-module to process the document data to produce the print data in the appropriate format. As another example, the rendering module of the service client might render the service job into a universal format, such as a Bitmap image.

At step 1090, the service client sends the service job, which includes the job ticket and the rendered print data, to the network service selected in step 1050 or step 1060. This step may be performed by a port management module of the service client, such as integrated service port management module 338 of FIG. 3.

### Service Ticket Creation

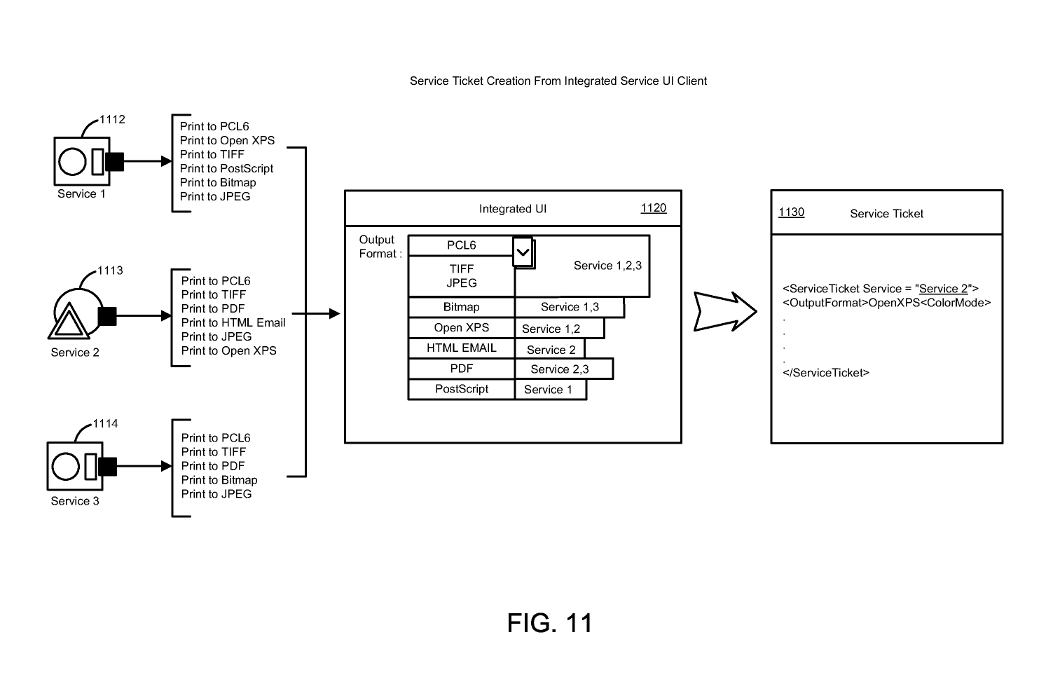

FIG. 11 is a flow diagram that depicts an example of how a service ticket 1130 is created, according to an embodiment. In this example, services 1112-1116 are print services. One of the features of each of services 1112-1116 is output format. Each of services 1112-1116 supports a different set of options for the output format feature. In the depicted example, service 1112 supports printing to PCL6, Open XPS, TIFF, PostScript, Bitmap, and JPEG while service 1116 supports printing to PCL6, TIFF, PDF, Bitmap, and JPEG.

The options supported by each of services 1112-1116 may be reflected in a UI GSDD, from which is generated integrated UI 1120. Integrated UI 1120 may be generated by a service client application executing on a client device or may be provided, over a network, from a service server that executes remote relative to the client device that displays integrated UI 1120.

In the depicted example, integrated UI 1120 displays 11 different options for the output format feature. A user selects “Open XPS” displayed in the drop down menu of integrated UI 1120. Based on this selection (and one or more other selections), service ticket 1130 is generated.

Service ticket 1130 may be generated by a service client executing on a client device or by a service server executing on a device that is remote relative to the client device that displays integrated UI 1120. Service ticket 1130 indicates that “Service 2” (or service 1114) was selected and that the output format is Open XPS.

### Adding a Service Provider to a Service Server

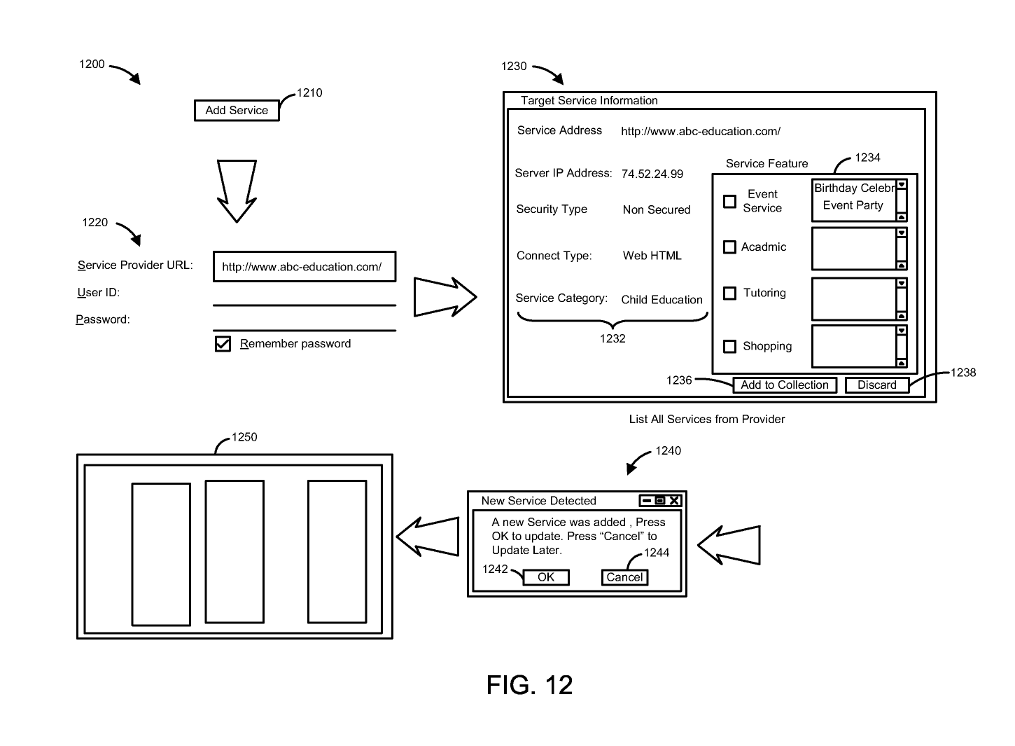

FIG. 12 is a diagram that depicts an example process 1200 for adding a service provider to a service server, according to an embodiment. In this example, process 1200 begins by a user (or, more specifically, an administrator) selecting an Add Service button 1210, which may be the same as Add Service button 750 displayed in user interface 700. Selection of Add Service button 1210 causes a window 1220 to be displayed that includes three text fields: a service provider URL text field, a User ID text field, and a Password text field. Window 1220 also includes an option for the client application that provides window 1220 to remember a password that a user enters in the Password text field. Upon entering of the required information, window 1230 is displayed.

Window 1230 includes service attribute information 1232, feature set 1234, an Add to Collection button 1236, and a Discard button 1238. Service attribute information 1232 indicates a URL address of a particular service, an IP address of the particular service, the security type of the particular service, the connection type of the particular service, and the category of the particular service. Feature set 1234 indicates at least four features of the particular service: an Event Service feature, an Academic feature, a Tutoring feature, and a Shopping feature. Each feature is associated with multiple options, such as Birthday Celebration, Event Party, and Graduate Celebration for the Event Service feature.

Selection of Add to Collection button 1236 causes the particular service to be added to a database, such as a Service GSDD or a Client GSDD. Selection of Discard button 1238 causes window 1230 to disappear and, thus, prevents the particular service from being added to the database.

In the depicted example, Add to Collection button 1236 is selected, which causes window 1240 to be displayed. Window 1240 indicates that the particular service, described in window 1230, was added. Window 1240 includes two buttons: an OK button 1242 and a Cancel button 1244. Selection of OK button 1242 causes a user interface (such as user interface 700) to be updated immediately and, optionally, a UI GSDD to be updated immediately. Selection of Cancel button 1244 causes the user interface to be updated later, rather than immediately.

After window 1240 is displayed, window 1250 is displayed (e.g., in response to selection of OK button 1242). Window 1250 displays a user interface, similar to user interface 700. The user interface may include information about the particular service added during process 1200.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

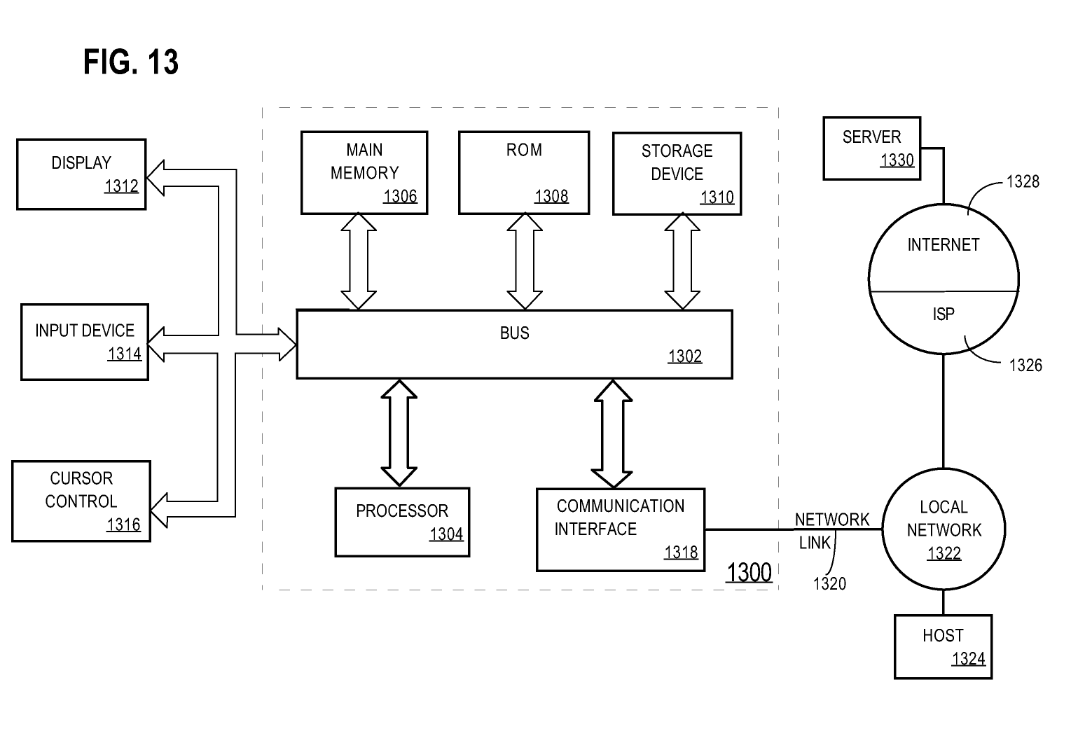

For example, FIG. 13 is a block diagram that illustrates a computer system 1300 upon which an embodiment of the invention may be implemented. Computer system 1300 includes a bus 1302 or other communication mechanism for communicating information, and a hardware processor 1304 coupled with bus 1302 for processing information. Hardware processor 1304 may be, for example, a general purpose microprocessor.

Computer system 1300 also includes a main memory 1306, such as a random access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Such instructions, when stored in non-transitory storage media accessible to processor 1304, render computer system 1300 into a special-purpose machine that is customized to perform the operations specified in the instructions.

Computer system 1300 further includes a read only memory (ROM) 1308 or other static storage device coupled to bus 1302 for storing static information and instructions for processor 1304. A storage device 1310, such as a magnetic disk or optical disk, is provided and coupled to bus 1302 for storing information and instructions.

Computer system 1300 may be coupled via bus 1302 to a display 1312, such as a cathode ray tube (CRT), for displaying information to a computer user. An input device 1314, including alphanumeric and other keys, is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312. This input device typically has two degrees of freedom in two axes, a first axis (e.g., x) and a second axis (e.g., y), that allows the device to specify positions in a plane.

Computer system 1300 may implement the techniques described herein using customized hard-wired logic, one or more ASICs or FPGAs, firmware and/or program logic which in combination with the computer system causes or programs computer system 1300 to be a special-purpose machine. According to one embodiment, the techniques herein are performed by computer system 1300 in response to processor 1304 executing one or more sequences of one or more instructions contained in main memory 1306. Such instructions may be read into main memory 1306 from another storage medium, such as storage device 1310. Execution of the sequences of instructions contained in main memory 1306 causes processor 1304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1310. Volatile media includes dynamic memory, such as main memory 1306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1302. Transmission media can also take the form of acoustic or light waves, such as those generated during radio-wave and infra-red data communications.

Various forms of media may be involved in carrying one or more sequences of one or more instructions to processor 1304 for execution. For example, the instructions may initially be carried on a magnetic disk or solid state drive of a remote computer. The remote computer can load the instructions into its dynamic memory and send the instructions over a telephone line using a modem. A modem local to computer system 1300 can receive the data on the telephone line and use an infra-red transmitter to convert the data to an infra-red signal. An infra-red detector can receive the data carried in the infra-red signal and appropriate circuitry can place the data on bus 1302. Bus 1302 carries the data to main memory 1306, from which processor 1304 retrieves and executes the instructions. The instructions received by main memory 1306 may optionally be stored on storage device 1310 either before or after execution by processor 1304.

Computer system 1300 also includes a communication interface 1318 coupled to bus 1302. Communication interface 1318 provides a two-way data communication coupling to a network link 1320 that is connected to a local network 1322. For example, communication interface 1318 may be an integrated services digital network (ISDN) card, cable modem, satellite modem, or a modem to provide a data communication connection to a corresponding type of telephone line. As another example, communication interface 1318 may be a local area network (LAN) card to provide a data communication connection to a compatible LAN. Wireless links may also be implemented. In any such implementation, communication interface 1318 sends and receives electrical, electromagnetic or optical signals that carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the world wide packet data communication network now commonly referred to as the “Internet” 1328. Local network 1322 and Internet 1328 both use electrical, electromagnetic or optical signals that carry digital data streams. The signals through the various networks and the signals on network link 1320 and through communication interface 1318, which carry the digital data to and from computer system 1300, are example forms of transmission media.

Computer system 1300 can send messages and receive data, including program code, through the network(s), network link 1320 and communication interface 1318. In the Internet example, a server 1330 might transmit a requested code for an application program through Internet 1328, ISP 1326, local network 1322 and communication interface 1318.

The received code may be executed by processor 1304 as it is received, and/or stored in storage device 1310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more storage media storing instructions which, when executed by one or more computing devices, cause:
receiving, at a client device, service feature and option data that include features and options supported by a plurality of network services;
generating, by an application program executing on the client device, a user interface based on the service feature and option data, wherein the user interface indicates the features and options supported by the plurality of network services;
receiving, through the user interface, input that selects one or more features and options reflected in the service feature and option data;
based on the input, the application program:
selecting a particular network service from among the plurality of network services, and
generating a service job based on the selected one or more features and options;
causing, by the application program, the service job to be sent to the particular network service.

2. The one or more storage media of claim 1, wherein the service feature and option data is received, over a network, from a server that is separate from the client device and that receives the service feature and option data from the plurality of network services.

3. The one or more storage media of claim 1, wherein the instructions, when executed by the one or more processors, further cause:
receiving second input that indicates user selection of one or more preferences;
based on the second input, identifying a current set of selected preferences that is different than a prior set of selected preferences that reflect a set of selected preferences that existed prior to receiving the second input;
identifying a current set of one or more network services that support the current set of selected preferences, wherein the current set of one or more network services is different than a prior set of one or more network services that support the prior set of selected preferences.

4. The one or more storage media of claim 3, wherein the one or more preferences indicate one or more of the following: a type of connection to a network service, whether a network service is secured, a category or type of network service, what type of credentials are required for logging in to a network service, a provider of a network service, whether payment is required for using a network service.

5. The one or more storage media of claim 3, wherein the instructions, when executed by the one or more processors, further cause:
after identifying the current set of one or more network services, displaying, through the user interface, information about each network service in the current set of one or more network service.

6. The one or more storage media of claim 3, wherein the current set of one or more network services comprises multiple network services, wherein the instructions, when executed by the one or more processors, further cause:
for each network service in the current set of network services:
identifying a particular set of features of options that said each network service supports;
updating the user interface to indicate the particular set of features and options, wherein prior to receiving the second input, the user interface indicated a previous set of features and options that is different than the particular set of features and options.

7. The one or more storage media of claim 1, wherein:
receiving the service feature and option data comprises receiving a software package that includes executable code that, when executed, causes the client device to generate the application program; and
the software package also includes the service feature and option data.

8. The one or more storage media of claim 1, wherein the instructions, which executed by one or more processors, further cause:
prior to receiving the service feature and option data, executing the application program at the client device; and
in response to receiving the service feature and option data, causing the application program to be updated to include the service feature and option data.

9. The one or more storage media of claim 1, wherein the instructions, which executed by one or more processors, further cause:
receiving and storing, at the client device, application program service description data (SDD) that includes information about features and options supported by multiple network services;
generating, based on the application program SDD, at the client device, user interface SDD that includes information about features and options supported by a subset of the multiple network services, wherein the user interface SDD is a subset of the application program SDD.

10. The one or more storage media of claim 1, wherein the application program comprises an integrated user interface module that is configured to generate the user interface, an update module that is configured to update the application program, and one or more rendering modules that are configured to generate service jobs based on selected features and options.

11. One or more storage media storing instructions which, when executed by one or more processors, cause:
receiving, at a server, over a network, from a first network service, first service feature and option data that indicates features and options supported by the first network service;
receiving, at the server, over the network, from a second network service that is different than the first network service, second service feature and option data that indicates features and options supported by the second network service;
storing combined service feature and option data that indicates multiple features and options supported by a plurality of network services that includes the first network service and the second network service;
causing the combined service feature and option data to be displayed concurrently at a client device to allow a user of the client device to select one or more features and options;
receiving, from the client device, selection data that indicates user selection of a plurality of features and options;
identifying a particular network service, of the plurality of network services, that supports the plurality of features and options, wherein the particular network service is determined automatically based on the selection data.

12. The one or more storage media of claim 11, wherein:
receiving the first service and option data over the network comprises using a first communications protocol to communicate with the first network service;
receiving the second service and option data over the network comprises using a second communications protocol that is different than the first communications protocol to communicate with the second network service.

13. The one or more storage media of claim 11, wherein:
prior to sending the first and second service feature and option data to the client device:
the client device executes an application program, and
the application program does not include the first and second print feature and option data; and
after sending the first and second service feature and option data to the client device, the application program is updated to include the first and second print feature and option data.

14. The one or more storage media of claim 11, wherein sending the first and second service feature and option data to the client device comprises:
generating, at the network server, an application program that is based on the first and second service feature and option data; and
sending the application program to one or more client devices that includes the client device.

15. The one or more storage media of claim 11, wherein the application program generates a user interface based on the first and second service feature and option data.

16. The one or more storage media of claim 11, wherein causing the combined service feature and option data to be displayed comprises:
receiving, from the client device, a request for a user interface that includes feature and option data of multiple network services;
sending, to the client device, the user interface that includes the combined service feature and option data.

17. The one or more storage media of claim 11, wherein the second network service supports a feature that the first network service does not support.

18. The one or more storage media of claim 11, wherein the instructions, when executed by the one or more processors, further cause, prior to sending the first and second service feature and option data to the client device:
reading policy data from storage associated with the network server;
applying one or more criteria indicated in the policy data to one or more attributes of the first network service and to one or more attributes of the second network service;
wherein the one or more attributes of the first network service and of the second network service must satisfy the one or more criteria indicated in the policy data in order for the first and second service feature and option data to be sent to the client device.

19. The one or more storage media of claim 18, wherein:
the policy data is particular policy data;
the instructions, when executed by the one or more processors, further cause:
storing first policy data that is different than the particular policy data, wherein the first policy data is associated with a first client device;
storing second policy data that is different than the particular policy data and first policy data, wherein the second policy data is associated with a second client device that is different than the first client device;
applying one or more criteria indicated in the first policy data to one or more attributes of the first network service;
wherein the one or more attributes of the first network service must satisfy the one or more criteria indicated in the first policy data in order for the first service feature and option data to be sent to the first client device;
applying one or more criteria indicated in the second policy data to one or more attributes of the first network service;
wherein the one or more attributes of the first network service must satisfy the one or more criteria indicated in the second policy data in order for the first service feature and option data to be sent to the second client device.

20. The one or more storage media of claim 18, wherein:
the policy data is first policy data;
the client device is a first client device;
the first policy data is associated with the first client device;
the instructions, when executed by the one or more processors, further cause:
storing second policy data that is different than the first policy data and that is associated with a second client device that is different than the first client device;
applying one or more criteria indicated in the second policy data to one or more attributes of the first network service;
wherein the one or more attributes of the first network service must satisfy the one or more criteria indicated in the second policy data in order for the first service feature and option data to be sent to the second client device.

21. The one or more storage media of claim 18, wherein the instructions, when executed by one or more processors, further cause:
in response to receiving input, updating the policy data to generate updated policy data;
identifying a plurality of network services that the network server has discovered; and
for each network service of the plurality of network services, applying one or more criteria indicated in the updated policy data to one or more attributes of said each network service, wherein the one or more attributes of said each network service must satisfy the one or more criteria indicated in the policy data in order for one or more client devices that are registered with the network server to receive service feature and option data associated with said each network service.
